(19) United States
(12) Patent Application Publication
(10) Pub. No.: US 2007/0124462 A1
(43) Pub. Date: May 31, 2007

(54) State Information Acquisition Processing Program, State Information Acquisition Apparatus, and State Information Acquisition System

(76) Inventors: Tsuyoshi Yamanaka, Komaki-shi (JP); Matatoshi Kadota, Takahama-shi (JP)

Correspondence Address: BANNER & WITCOFF, LTD.;ATTORNEYS FOR CLIENT NOS. 0166889, 006760, 1100 13th STREET, N.W., SUITE 1200, WASHINGTON, DC, 20005-4051, US

(21) Appl. No.: 11/565,212

(22) Filed: Nov. 30, 2006

(30) Foreign Application Priority Data
Nov. 30, 2005 (JP) P2005-346383

(51) Int. Cl. G06F 15/173

(52) U.S. Cl. 709/224

(57) ABSTRACT

A state information acquisition processing program embodied on a computer-readable medium, which when executed on a computer provided for an information processing apparatus, enables the computer to perform predetermined operations, the predetermined operations includes: detecting a change in a state of connections between the information processing apparatus and devices; determining whether communications are available with a target device that is switched, on receiving a state information request command after power on, to a state where state information indicating a state of the target device can be provided; transmitting a state information request command to the target device when a change in the state of connections with the devices is detected and the communication availability determining determines that communications with the target device are available; and acquiring the state information from the target device.

### CROSS-REFERENCE TO THE RELATED APPLICATION(S)

This application is based upon and claims priority from prior Japanese Patent Application No. 2005-346383 filed on Nov. 30, 2005, the entire content of which is incorporated herein by reference.

### TECHNICAL FIELD

The present invention relates to a state information acquisition processing program for causing a computer to command processing to acquire state information indicating a device state from a target device that enters a state where it can provide the state information on receiving a state information request command after power on, state information acquisition apparatus for acquiring the state information from the target device, and a state information acquisition system including the target device and the state information acquisition apparatus.

### BACKGROUND

The inventors have proposed a system for activating a status monitor based on a message from an operating system (OS) in case the OS has detected power ON of a device connected to a computer where the OS including a plug-and-play feature is installed or insertion of a communication cable connecting the device and the computer.

In this system, when the status monitor is activated, a command for requesting state information indicating the device state (hereinafter referred to as the state information request command) is transmitted from the status monitor to the device and state information can thereafter be acquired from the device.

The state information acquired from the device can be output to, for example, a display device, which lets the user know of the device state. In the case of the printer described in JP-A-2001-265546, the user knows the conditions of out of paper, paper jam or out of ink/toner condition. State information acquired from the device has other applications in addition to display. For example, by recording state information in a log file, the administrator is able to refer to the log file later to perform management tasks.

### SUMMARY

The technique described in JP-A-2001-265546 has room for improvement, to be discussed.

A computer has various devices connected thereto in addition to a device as a target of acquisition of state information (hereinafter referred to as the target device). Some of the OSs including a plug-and-play feature can transmit a message indicating a change in the device configuration in case the device is powered ON, although the message alone cannot convince the user that the target device has been powered ON.

Thus, an attempt to transmit a state information request command to the device on the condition that a message indicating the device configuration has changed is received may fail, thus resulting in trouble in subsequent processing.

A particular trouble experienced may depend on the type of system for communications between a computer and a device. For example, for the system described in JP-A-2001-265546, the target device is a printer so that a state information request command is transmitted via a spooler. When a state information request command is transmitted via a spooler while it is uncertain whether the target device is powered ON, the state information request command is placed in the hold state in the spooler in the case the target device is not powered ON, thus possibly outputting an unexpected error message to the user from the spooler system.

A computer may transmit a state information request command to some types of devices while bypassing a spooler. In the case a computer unidirectionally transmits a state information request command to a device, the computer assumes that the command has been transmitted although the device has not received the command, and performs the subsequent processing. This could result in an error in an attempt to acquire state information.

In the technique described in JP-A-2001-265546, a class driver activates the status monitor. Depending on an OS, a general vendor is not authorized to create a class driver or a method for creating a class driver is not made public. The technique described in JP-A-2001-265546 cannot be applied to such an OS.

In the technique described in JP-A-2001-265546, the status monitor is shut down when a device is disconnected from a universal serial bus (USB) port or a device is powered OFF. The user watching the status monitor display could assume that some abnormality has occurred in the status monitor resulting in an abnormal end. Also in a system where an application is monitoring the display on the status monitor like the user, the application suddenly fails to monitor the display on the status monitor.

Aspects of the invention are to provide a state information acquisition processing program, to provide a state information acquisition apparatus, and to provide a state information acquisition system capable of reliably transmitting a state information request command to a target device even in the case it is newly detected that a device is connected although not certain whether the device is a target of processing.

According to an aspect of the invention, there is provided a state information acquisition processing program embodied on a computer-readable medium, which when executed on a computer provided for an information processing apparatus, enables the computer to perform predetermined operations, the predetermined operations including: detecting a change in a state of connections between the information processing apparatus and devices; determining whether communications are available with a target device that is switched, on receiving a state information request command after power on, to a state where state information indicating a state of the target device can be provided; transmitting a state information request command to the target device when a change in the state of connections with the devices is detected and the communication availability determining determines that communications with the target device are available; and acquiring the state information from the target device.

According to the above aspect, a state information request command is not transmitted to a device along when a change in the connection to the device is detected, but the state information request command is transmitted to the target device when it is determined that communications with the target device are available. This prevents various problems caused by a situation where a state information request command is transmitted to the target device while communications with the target device are unavailable. In case communications with the target device are available, a state information request command is transmitted to the target device and it is possible to appropriately acquire state information from the target device thereafter.

According to another aspect of the invention, there is provided a state information acquisition apparatus including: a detection unit that detects a change in the state of connections between the information processing apparatus and devices; a communication availability determination unit that determines whether communications with a target device are available, the target device being switched to a state where the state information indicating a state of the device can be provided when a state information request command is received after power on; a state information request command unit that transmits the state information request command to the target device when a change in the state of connections with the devices is detected and the communications availability determination unit determines that communications with the target device are available; and a state information acquisition unit that acquires the state information from the target device.

According to the above aspect, it is possible to prevent various problems caused by a situation where a state information request command is transmitted to the target device while communications with the target device are unavailable. In case communications with the target device are available, a state information request command is transmitted to the target device and it is possible to appropriately acquire state information from the target device thereafter.

According to another aspect of the invention, there is provided a state information acquisition system including: a target device that is switched, on receiving a state information request command after power on, to a state where state information indicating a state of the target device can be provided; and a state information acquisition apparatus to which the target device can be connected, wherein the state information acquisition apparatus includes: a detection unit that detects a change in a state of connections between a information processing apparatus and devices; a communication availability determination unit that determines whether communications with the target device are available; a state information request command unit that transmits the state information request command to the target device when a change in the state of connections with the devices is detected and the communications availability determination unit determines that communications with the target device are available; and a state information acquisition unit that acquires the state information from the target device.

According to the above aspect, it is possible to prevent various problems caused by a situation where a state information request command is transmitted to the target device while communications with the target device are unavailable. In case communications with the target device are available, a state information request command is transmitted to the target device and it is possible to appropriately acquire state information from the target device thereafter.

According to another aspect of the invention, there is provided a state information acquisition processing program embodied on a computer-readable medium, which when executed on a computer provided for an information processing apparatus, enables the computer to perform predetermined operations, the predetermined operations including: detecting a change in the state of connections with devices; acquiring state information from a target device, the target device being switched to a state where the state information indicating a state of the device can be provided when a state information request command is received after power on; reporting the state information acquired by the state information acquiring when a change in the state of connections with the devices is detected; and transmitting the state information request command to the target device when a change in the state of connections with the devices is detected.

According to the above aspect, state information is detected even in case a change in connection with devices is detected. Unlike state information acquisition apparatus that stops reporting of state information, it is possible to prevent the user from assuming that a process (such as status monitor) running based on the state information acquisition processing program is abnormal upon a change in the connection state of a device. It is also possible to prevent a situation where an application monitoring the process running based on the state information acquisition processing program suddenly loses sight of the monitoring target.

According to another aspect of the invention, there is provided a state information acquisition apparatus including: a detection unit that detects a change in the state of connections with devices; a communication acquisition unit that acquiring state information from a target device, the target device being switched to a state where the state information indicating a state of the device can be provided when a state information request command is received after power on; a state information report unit that reports the acquired state information when a change in the state of connection with the devices is detected by the detection unit; and a state information request command unit that transmits the state information request command to the target device when a change in the state of connections with the devices is detected.

According to the above aspect, unlike state information acquisition apparatus that stops reporting of state information, it is possible to prevent the user from assuming an abnormality in the state information acquisition apparatus upon a change in the connection state of a device. It is also possible to prevent a situation where an application monitoring the process being performed by the state information acquisition apparatus suddenly loses sight of the monitoring target.

According to another aspect of the invention, there is provided a state information acquisition system including: a target device that is switched, on receiving a state information request command after power on, to a state where state information indicating a state of the target device can be provided; and a state information acquisition apparatus to which the target device can be connected, wherein the state information acquisition apparatus includes: a detection unit that detects a change in a state of connections with devices; a communication acquisition unit that acquiring state information from a target device, the target device being switched to a state where the state information indicating a state of the device can be provided when a state information request command is received after power on; a state information report unit that reports the state information acquired by the state information acquisition apparatus when a change in the state of connections with the devices is detected; and a state information request command unit that transmits the state information request command to the target device when a change in the state of connections with the devices is detected.

According to the above aspect, unlike a system where the state information acquisition apparatus stops reporting of state information, it is possible to prevent the user from assuming an abnormality in the state information acquisition apparatus upon a change in the connection state of a device. It is also possible to prevent a situation where an application monitoring the process being performed by the state information acquisition apparatus suddenly loses sight of the monitoring target.

### BRIEF DESCRIPTION OF THE DRAWINGS

FIG. 1 is a general block diagram showing the configuration of an entire system including a PC and a printer;

FIG. 2 shows the configuration of the software in the PC;

FIG. 3 is an explanatory drawing that illustrates state information output by a printer and state information output by a parser;

FIG. 4 is a flowchart of main processing performed by a status monitor UI;

FIG. 5 is a flowchart of message loop processing performed by the status monitor UI;

FIG. 6 is a flowchart of main processing performed by the parser;

FIG. 7 is a flow chart of initialization message processing performed by the parser;

FIG. 8 is a flowchart of end message processing performed by the parser;

FIG. 9 is a flowchart of device configuration change message processing performed by the parser;

FIG. 10 is a flowchart of timer message processing performed by the parser; and

FIG. 11 is a flowchart of a variation example of timer message processing performed by the parser.

### DETAILED DESCRIPTION

An aspect of the invention will be described.

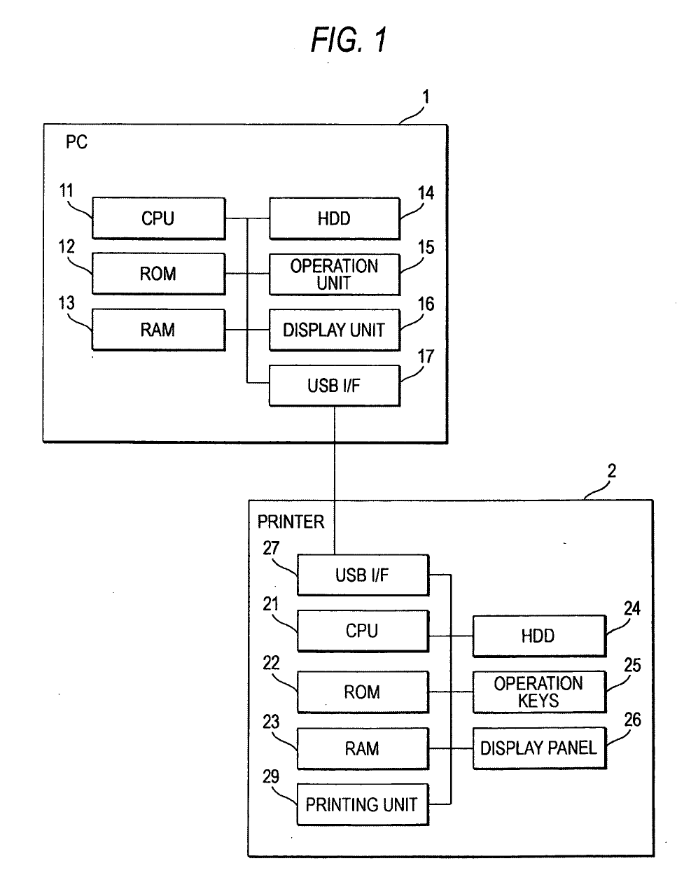

FIG. 1 is a general block diagram showing the configuration of an entire system including a personal computer 1 (hereinafter referred to as the PC 1) and a printer 2.

As shown in FIG. 1, the PC 1 includes a CPU 11, a ROM 12, a RAM 13, a hard disk drive 14 (hereinafter referred to as the HDD 14), an operation unit 15, a display unit 16, and a USB interface 17 (hereinafter referred to as the USB I/F 17).

The CPU 11 is a device for performing control of the components of the PC 1 and various arithmetic operations in accordance with programs stored in the ROM 12 or RAM 13.

The ROM 12 is a storage device that can retain storage content even when the power switch of the PC 1 is turned off. The ROM 12 stores the BIOS (Basic Input Output System) and data to be loaded that is typically not updated.

The RAM 13 is a storage device used as a main memory directly accessed from the CPU 11. Software such as an OS and various applications are loaded to the RAM 13 from the HDD 14.

The HDD 14 is a device for storing the OS, various application programs and data files.

The operation unit 15 is an input device for the user to input commands and includes a keyboard and pointing devices such as a mouse.

The display unit 16 is an output device for presenting various types of information to the user and includes a liquid crystal display capable of displaying a color image.

The USB I/F 17 is a serial interface conforming to the USB Standard. It is possible to connect various devices including a printer, a keyboard, a mouse, a scanner, a speaker and storage devices. In this aspect, a printer 2 is connected to the USB I/F 17.

The printer 2 includes a CPU 21, a ROM 22, a RAM 23, operation keys 25, a display panel 26, a USB I/F 27, and a printing unit 29.

The CPU 21 is a device for performing control of the components of the printer 2 and various arithmetic operations in accordance with control programs stored in the ROM 22.

The ROM 22 is a storage device that can retain storage content even when the power switch of the printer 2 is turned off. The ROM 12 stores the control programs and data to be loaded that is typically not updated.

The RAM 23 is a storage device used as a main memory directly accessed from the CPU 21. Various types of data calculated by the CPU 11 in processing are temporarily stored into the RAM 23.

The operation keys 25 are input devices manipulated by the user to manually enter a command to the printer 2.

The display panel 26 is an output device such as a compact liquid crystal display for displaying the setting or state of the printer 2.

The USB I/F 27 is a serial interface conforming to the USB Standard. It is possible to perform communications with the PC 1 via the USB I/F 27.

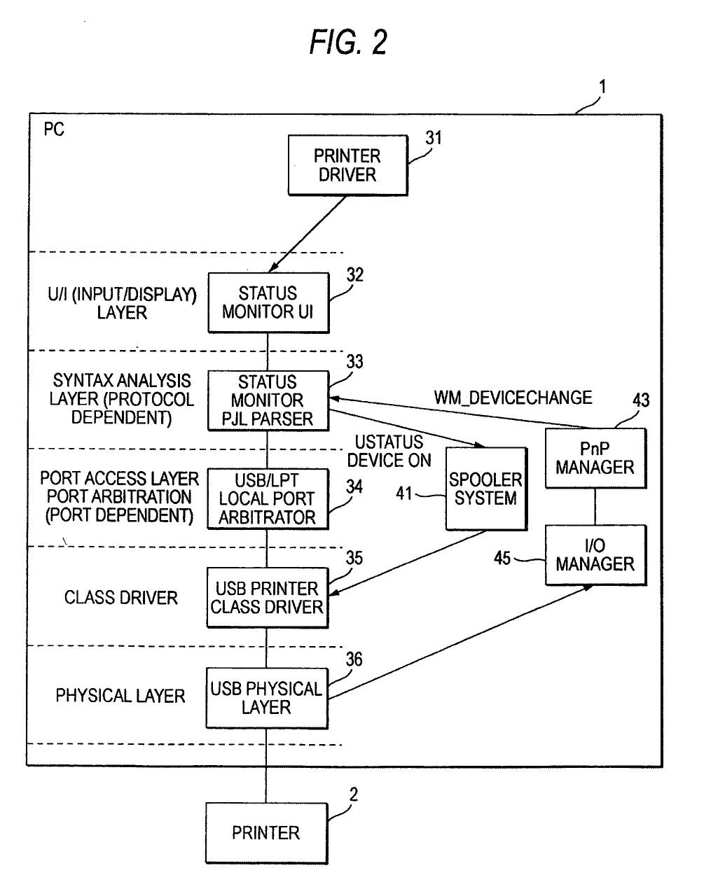

The printing unit 29 is a unit for printing on a sheet-shaped medium such as recording paper. FIG. 2 is a block diagram of the components related to the processing of acquiring state information from the printer 2 out of the software and hardware components of the PC 1.

The PC 1 has an OS including a multitask feature installed therein. Multiple processes function in parallel and the multiple processes work together to perform various types of processing. A specific example of such an OS including a multitask feature is Windows®. While the features provided by the OS are well known and detailed description is omitted, the following description assumes that the PC 1 has various types of features provided by Windows®.

In PC 1, the processing system that performs processing to acquire state information from the printer 2 has a hierarchical structure including a UI (Input/Display) layer, a syntax analysis layer, a port access laser, a class driver, and a physical layer.

To be more specific, when printout is performed on the printer 2, a printer driver UI 31 performs printing-related processing, in which a status monitor UI 32 is activated as a process separate from the printer driver UI 31. Note that an arbitrary impetus to activate the status monitor UI 32 may be used. For example, aport monitor maybe designed to activate the status monitor UI 32, or the user may manually activate the status monitor UI 32.

The status monitor UI 32 is a process for executing processing to accept an input of information from the user or processing to display state information. In the processing, a status monitor PJL parser 33 (hereinafter also referred to as the parser 33) is activated as a process separate from the status monitor UI 32.

The status monitor PJL parser 33 outputs a command described in a form conforming to the printer job language (PJL) (hereinafter also referred to as the PJL command) to the printer 2 and acquires the state information output from the printer 2 that has received the PJL command. The status monitor PJL parser 33 also performs syntax analysis of the acquired state information, converts the state information to a data form that can be referenced by the status monitor UI 32, and outputs the resulting data to the status monitor UI 32. The PJL is a well-known command language capable of controlling various features of the printer 2 and acquiring the printer status developed by the Hewlett-Packard Development Company and thereafter employed by other companies.

The status monitor PJL parser 33 dynamically links a USB/LPT local port arbitrator 34 in its processing, thereby enabling the USB/LPT local port arbitrator 34. The USB/LPT local port arbitrator 34 makes arbitration between a process and another using the same port to maintain control so that data to be passed to a process will not be provided to another.

A USB printer class driver 35 is a feature of an OS and is activated when the PC 1 is activated or a device corresponding to each class driver is activated. A USB physical layer 36 is hardware constituting each printer port.

The OS installed in the PC 1 includes a spooler system 41, a PnP manager 43, and I/O manager 45.

The spooler system 41 centrally manages as a print job the print data output from a plurality of processes (such as applications) and sequentially transmits the print data to the printer 2 in accordance with the priorities specified by an FIFO or the user. In case the status monitor PJL parser 33 has output a PJL command, the PJL command is also managed by the spooler system 41 like other print data, and transmitted to the printer 2 via the printer cluster driver 36 and the USB physical layer 36. In this aspect, PJL commands “USTATUS DEVICE ON” and “INFO DEVICE” are transmitted to the printer 2 via the spooler system 41. As a result, the printer 2 enters a state where the printer 2 provides the state of the printer 2. Thereafter the status monitor PJL parser 33 can acquire state information from the printer 2.

The PJL command “USTATUS DEVICE ON” is a command to instruct a printer to return the information upon a change in the printer state. The PJL command “INFO DEVICE” is a command to instruct a printer to return the status at that point in time.

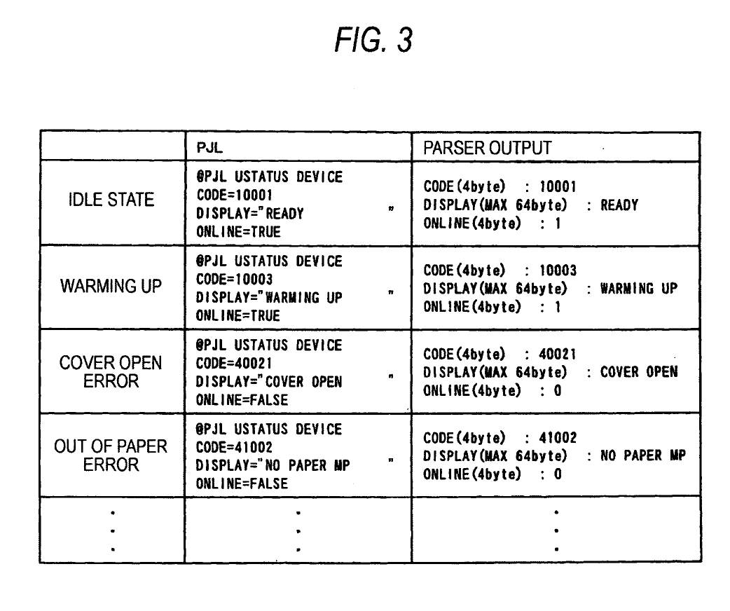

For example, the printer 2 enters a state where it can provide state information shown in the “PJL” column in FIG. 3 so that the status monitor PJL parser 33 can read back the state information from the printer 2. The status monitor PJL parser 33 converts the state information read from the printer 2 to binary data of up to 72 bytes shown in the “Parser output” column in FIG. 3 and outputs the converted state information to the higher-layer status monitor UI 32 via inter-process communications.

A PnP manager 43 and an I/O manager 45 have a feature to notify each process of a state change concerning connection or release of the printer 2. To be more specific, in case a state change has occurred concerning connection or release of the printer 2, the state change is detected by the I/O manager 45. The PnP manager 43 working in cooperation with the I/O manager 45 notifies each process of a message “WM_DEVICECHANGE”. Each process running on the PC 1 recognizes a state change concerning connection or release of the printer 2 based on report (message) from the PnP manager 43. In this aspect, recognizing a state change concerning connection or release of the printer 2, the status monitor PJL parser 33 performs corresponding processing. Details of the processing will be described later.

Next, details of state information acquisition processing performed on the PC 1 will be described. The state information acquisition processing is performed by the status monitor UI 32 and the status monitor PJL parser 33 in cooperation with each other.

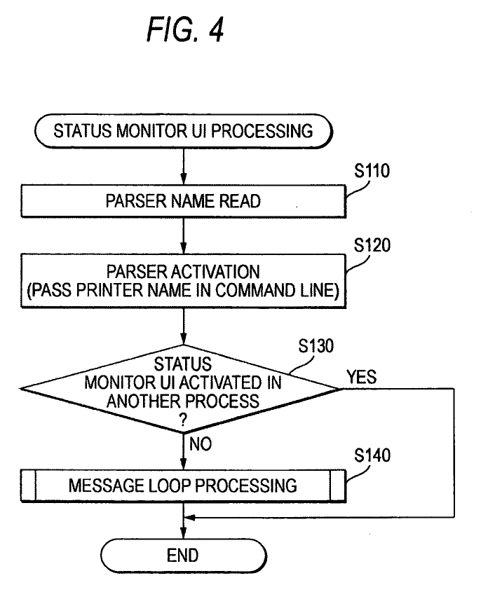

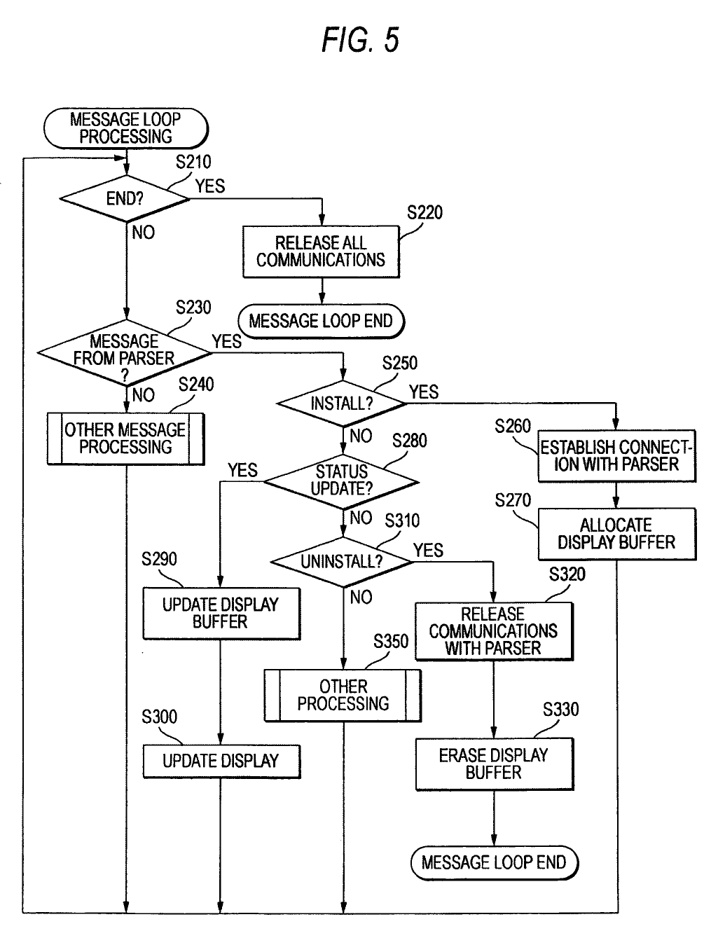

The processing performed by the status monitor UI 32 will be described based on the flowcharts of FIGS. 4 and 5.

Starting this processing, the status monitor UI 32 reads a parser name (S110). The parser name read in this step is a parser name that corresponds to a printer supported by the status monitor UI 32 and is registered to a configuration file (printer 2 in this aspect).

The status monitor UI 32 uses the parser name read in step S110 to activate the parser 33 as a separate process (S120). The status monitor UI 32 passes the printer name in a command line to the parser 33.

The status monitor UI 32 determines whether the status monitor UI 32 has been activated in another process (S130). In case the status monitor UI 32 has not been activated (S130: NO), execution proceeds to message loop processing (S140). In case status monitor UI 32 has been activated (S130: YES), or in case S140 is complete, this processing is terminated.

The message loop processing in S140 is shown in greater detail in the flowchart of FIG. 5. In the message loop processing, a sequence of processings is repeated where the status monitor UI 32 determines the content of an incoming command message and accordingly performs processing.

To be more specific, the status monitor UI 32 determines whether a command message is the instruction to terminate the process (S210). In case it is the instruction to terminate the process (S210: YES), the status monitor UI 32 releases the communications with the other processes and complete the message loop processing. (S220)

In case the command message is not the instruction to terminate the process (S210: NO), the status monitor UI 32 determines whether the command message is a message from the parser 33 (S230). A message from the parser 33 is an incoming message from the process of the parser 33 activated in step S120. While the details of the processing performed by the parser 33 will be described later, the status monitor UI 32 performs various types of processing with the parser 33 via inter-process communications in this message loop processing.

In case the message is not an incoming message from the parser 33 in S230 (S230: NO), the status monitor UI 32 performs processing concern to the messages and execution returns to S210.

In case the message is an incoming message from the parser 33 in S230 (S230: YES), the status monitor UI 32 determines whether the command in the message is “Install” (S250). In case the command is “Install” (S250: YES), the status monitor UI 32 establishes a connection with the parser 33 (S260). The particular procedure or method for communicating with the parser 33 is not limited as long as data communications are available between processes. In this aspect, data is attached to a shared memory allocated in the processing by the parser 33 described later and data is communicated between processes via the shared memory. The status monitor UI 32 allocates a display buffer (S270) and execution returns to S210. The display buffer is used to output state information on the display unit 16 of the Pc 1.

In case the command is not “Install” (S250: NO), the status monitor UI 32 determines whether the command in the message is “Status update” (S280). In case the command is “Status update” (S280: YES), the status monitor UI 32 reads state information from the attached shared memory and writes the state information onto the display buffer to update the data (S290). The display buffer is a memory allocated in the step S270. When the display buffer is updated, the status monitor UI 32 performs a control to update the display on the display unit 16 in order to actually present the updated state information on the display unit 16 of the PC 1, and execution returns to S210.

In case the command is not “Status update” (S280: NO), the status monitor UI 32 determines whether the command is “Uninstall” (S310). In case the command is “Uninstall” (S310: YES), the status monitor UI 32 releases the connection with the parser 33 (S320). To be more specific, the status monitor UI 32 detaches the shared memory attached in S260 in this aspect. In case means other than a shared memory is used to provide inter-process communications in S260, the status monitor UI 32 releases the resource secured for the inter-process communications. Then, the status monitor UI 32 erases the display buffer allocated in S270 (S330) and completes the message loop processing.

In case the command is not “Uninstall” (S310: NO), the status monitor UI 32 performs the other processing (S350) and execution returns to S210. The other processing is not related to the essence of the invention, so detailed description is omitted.

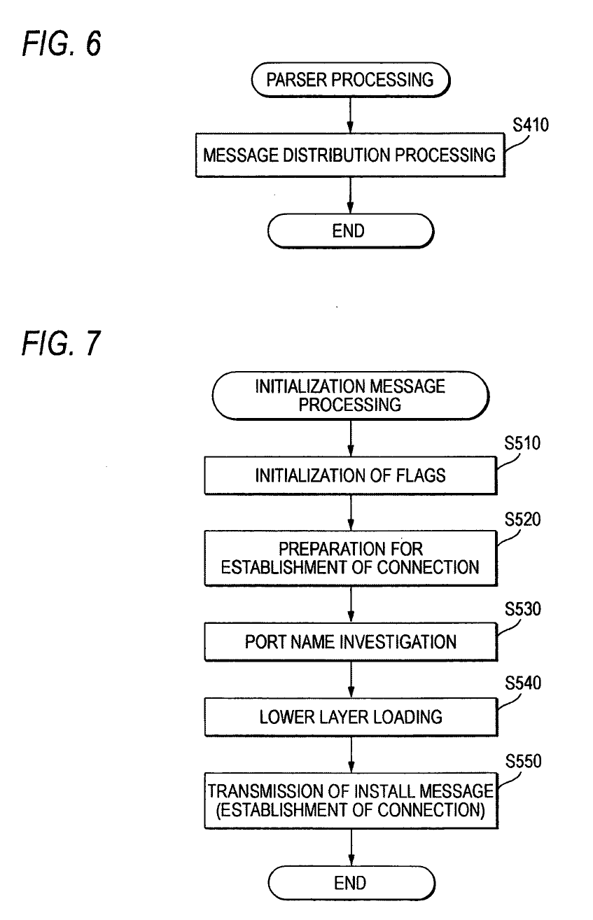

In parallel with the message loop processing made by the status monitor UI 32, the parser 33 activated in S120 performs processing shown in FIGS. 6 through 10.

In particular, the parser 33 first performs processing shown in FIG. 6 and performs message distribution processing in S410. The processing in S410 is made in accordance with a satisfied condition out of the processing including that as shown in FIGS. 7 to 10. In case the satisfied condition is an end condition, the processing of S410 is terminated. In such a case, the entire processing shown in FIG. 6 is terminated. Otherwise, the processing S410 is not terminated by execution but waits until a predetermined condition is satisfied, and processing is performed in accordance with a satisfied condition when the predetermined condition is satisfied. In S410, processing in accordance with a satisfied condition is repeated each time a condition other than an end condition is present until the end condition is satisfied.

Processing to be performed in case various types of conditions are satisfied in S410 will be described. First, initialization message processing shown in FIG. 7 will be described. The initialization message processing is performed in case a condition is satisfied where the parser 33 has been just activated.

Starting the initialization message processing, the parser 33 initializes various flags (S510). In the processing of S510, OFF is set to as a device connect/disconnect flag, a state information request command transmission complete flag, and a communication unavailability indication flag as an initial value and a communication failure counter is zero-cleared.

The parser 33 then makes prepares for establishing connection with the status monitor UI 32 (S520). In particular, processing to allocate a memory area as a shared memory is made. The parser 33 investigates a port name used by a printer name passed as an argument (issued by status monitor at S120) when the parser 33 was activated (S530) and loads a lower layer (local port arbitrator) corresponding to the port name (S540). A program loaded in S540 is provided as a dynamic link library (hereinafter also referred to as the DLL). A process to perform processing as the parser 33 loads an arbitrator corresponding to the port name. The parser 33 thereafter uses the arbitrator corresponding to the port used by the printer as a processing target to acquire state information.

When the processing is complete, the parser 33 transmits an install message to the process of the status monitor UI 32 (S550). The message works as an impetus for performing the steps S250 to S270 in the message loop processing by the status monitor UI 32 described above. When the processing by the status monitor UI 32 is complete, connection between the status monitor UI 32 and the parser 33 is established.

When S550 is complete, the initialization message shown in FIG. 7 is complete. The parser 33 thereafter waits until a predetermined condition is satisfied again in the processing of S410.

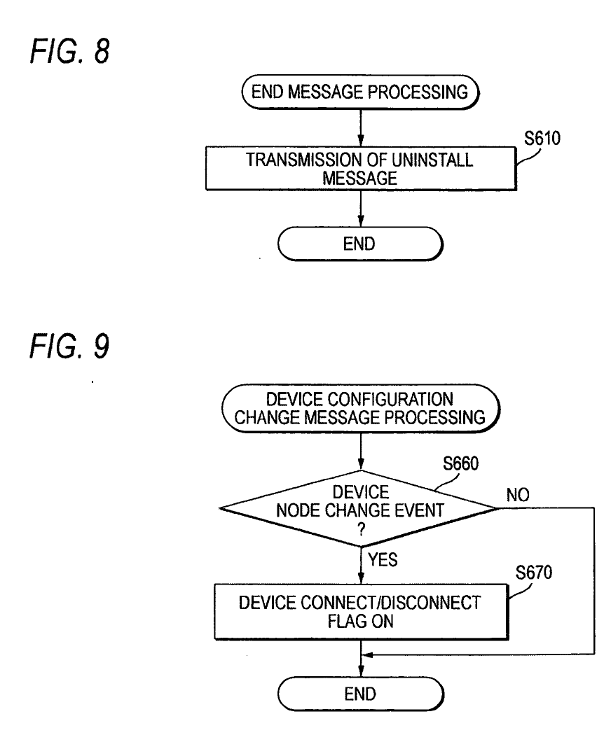

Next, the end message processing shown in FIG. 8 will be described. The end message processing is performed in case an end condition is satisfied. For example, in case the user manipulates the operation unit 15 and inputs a predetermined end condition, the end condition is satisfied and end message processing is performed. An end condition may be satisfied depending on an error or some other circumstances.

Starting the end message processing, the parser 33 transmits an “Uninstall” message (S610). This message works as an impetus for performing the steps S310 to S330 in the message loop processing by the status monitor UI 32 described above. When completing S610, the parser 33 releases the shared memory provided in S520, and terminates the end message processing shown in FIG. 8. By terminating the end message processing, the parser 33 terminates step S410.

Next, device configuration change message processing shown in FIG. 9 will be described. In this aspect, Windows® is installed as an OS in the PC 1. In case the configuration of a device connected to the PC 1 is changed, such as in a case the power switch of the printer 2 is toggled between ON and OFF or in a case a communication cable for connecting the PC 1 to the printer 2 is inserted/removed, a message “WM_DEVICECHANGE” is transmitted from the PnP manager 43 to the parser 33. The device configuration change message described below is performed in case a condition that the message “WM_DEVICECHANGE” is transmitted from the PnP manager 43 is satisfied.

Starting the device configuration change message processing, the parser 33 determines whether an event that has taken place is a device change event (“DBT_DEVNODES_CHANGED” event) (S660). To be more specific, in case the message “WM_DEVICECHANGE” is transmitted to the parser 33, the message has some parameters attached thereto. In S660, the parser 33 determines whether a parameter attached to the message is “DBT_DEVNODES_CHANGED”.

In case the event is a device change event (“DBT_DEVNODES_CHANGED” event) (S660: YES), the parser 33 turns ON the device connect/disconnect flag (S670) and terminates the device configuration change message processing. In case the event is not device change event (“DBT_DEVNODES_CHANGED” event) (S660: NO), the parser 33 skips the processing of S670 and terminates the device configuration change message processing. The device connect/disconnect flag set to ON in S670 is referenced in the timer message processing described later.

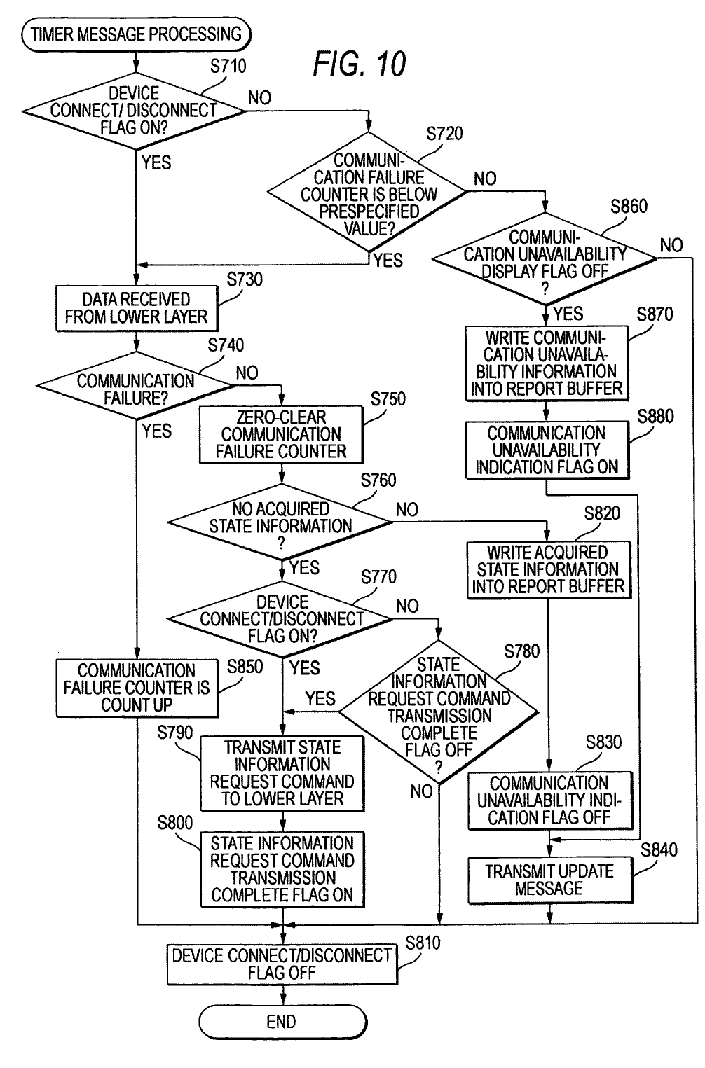

Next, the timer message processing shown in FIG. 10 will be described. The timer message processing is performed in case a condition that a predetermined time has elapsed is satisfied, that is, the processing is repeated each time a predetermined time has elapsed. The values of flags change in the repetitive processing so that the processing flow in the timer message processing may change at any time.

In the following description, the flow of timer message processing in accordance with an assumed situation will be described while considering various situations in the course of the timer message processing.

Description is continued assuming a case where the timer message processing is performed for the first time in the situation where communications with the printer 2 is normally available as an initial stage.

Starting the timer message processing, the parser 33 determines whether the device connect/disconnect flag is ON (S710). While the device connect/disconnect flag may be turned ON when the device configuration change message processing (FIG. 9) is performed, the device connect/disconnect flag usually remains OFF (initial value) in the initialization message processing (FIG. 7). Description will continue while assuming that the device connect/disconnect flag is OFF. The opposite case where the device connect/disconnect flag is ON will be described later.

While the device connect/disconnect flag is OFF (S710), the parser 33 determines whether the value of the communication failure counter is below a prespecified value (for example 5) (S720). While the communication failure counter may be incremented on failure to communicate with the printer 2, it is zero-cleared in the initial message processing (FIG. 7) in the initial stage.

In case it is determined that the value of the communication failure counter is below a prespecified value (S720: YES), the parser 33 receives data (state information) from a lower layer (arbitrator 34) (S730) and determines whether the system has failed in the communications (S740). To be more specific, in S730, the parser 33 performs negotiation with the printer 2 to establish a connection, and then receives state information. In S740, the parser 33 determines that communications are successful when a connection has been established and state information has been successfully received. When a connection has not been established or when reception of state information has abnormally ended, the parser 33 determines that communications are unsuccessful.

In case the printer 2 is powered ON and normal communications are available with the printer 2 in S740, the parser 33 determines that communications are successful (S740: NO). The parser 33 zero-clears the communication failure counter (S750) and determines whether there is data (state information) acquired in S730 (S760). While the processing of S760 is performed in case it is determined that communications are successful in S740, no data may have been acquired as a result of successful communications. In such a case, affirmative determination is made in S760.

In order to receive data (state information) in S730, a state information request command (PJL command) must be transmitted in advance to the printer 2 so as to engage the printer 2 to provide state information.

In the initial stage, S730 is performed without a state information request command (PJL command) being transmitted. Thus, data (state information) is not provided by the printer 2 and it is necessarily determined that there is no data acquired in S760 (S760: YES).

The parser 33 then determines whether the device connect/disconnect flag is ON (S770). In the initial stage, as assumed above, the device connect/disconnect flag is OFF (S770: NO). The parser 33 determines whether the state information request command transmission complete flag is OFF (S780). In the initial stage, the state information request command transmission complete flag is set to OFF (initial value) in the initialization message processing (FIG. 7). Thus the parser 33 makes affirmative determination in S780 (S780: YES). In such a case, the parser 33 transmits a state information request command to the printer 2 (S790).

An arbitrary method for transmitting a state information request command maybe used as long as a state information request command can be transmitted successfully to the printer in consideration of the target printer specifications or specifications of a printer board used by the printer. In this aspect, a PJL command is transmitted as a state information request command. The spooler system 41 of the PC 1 is used to process a PJL command as a single print job, thereby transmitting the state information request command (PJL command) to the printer 2. By transmitting a state information request command with the help of the spooler system 41, it is possible to prevent another print job and a state information request command (PJL command) from being transmitted simultaneously to the printer 2.

Having transmitted a state information request command to the printer 2, the parser 33 turns ON the state information request command transmission complete flag (S800), turns ON the device connect/disconnect flag (S810), and terminates the timer message processing shown in FIG. 10.

Next, the process of the timer message processing to be performed again will be described while assuming various situations after the initial stage.

In case the timer message processing is performed again, the parser 33 has already transmitted a state information request command to the printer 2 in S790, so that it can receive data (state information) from a lower layer arbitrator in S730.

In this aspect, for the data received in S730, the parser 33 allocates a memory working as a receive buffer and passes as an argument the address of the receive buffer to the arbitrator 34 (USB/LPT local port arbitrator 34). The arbitrator stores the data in an address specified by the parser 33 and the parser 33 receives the data. The arbitrator 34 then inputs the state information from the USB-connected printer 2 in accordance with the specifications of the USB printer class driver 35 and stores the state information into the receive buffer. In this way, the arbitrator 34 inputs state information in accordance with the specifications of the class driver 35 and the input state information is stored into the receive buffer in a system independent of the specifications of the class driver 35. This lets the parser 33 reference the state information stored into the receive buffer without considering the specifications of the printer board at all.

Whether the parser 33 acquires data from a lower layer depends on whether a change has occurred in the state of the printer 2. In case the parser acquired data from the lower layer in S730, it is determined that there is acquired data (state information) in S760 (S760: NO). In this case, the parser 33 writes state information into the report buffer for the status monitor UI 32 (S820). The report buffer to which state information is written in S820 is a shared memory. Writing data into the shared memory lets the status monitor UI 32 reference the latest state information.

The state information stored into the receive buffer is in a form of data which is dependent on the specifications of the printer 2 corresponding to the PJL specifications shown in FIG. 3. In S820, the parser 33 analyzes the characters and syntax of the state information stored into the receive buffer, converts the state information to a data form shown in the parser output column in FIG. 3, and writes the converted state information into the shared memory. This lets the status monitor UI 32 reference the state information stored into the shared memory without considering the PJL specifications at all.

Finishing the processing of S820, the parser 33 turns OFF the communication unavailability flag (S830) and transmits a status update message “Status update” to the process of the status monitor UI 32 (S840). This message works as an impetus for performing the steps S280 to S300 in the message loop processing by the status monitor UI 32 described above.

Terminating the processing of S840, execution proceeds to S810 described above and the timer message processing shown in FIG. 10 is complete.

In case the parser 33 did not acquire data from a lower layer in S730, it is determined that there is no acquired data (state information) in S760 (S760: YES). In this case, execution proceeds to S770 and S780. In case S800 is executed, the state information request command transmission complete flag is set to ON so that negative determination is made in S780 (S780: NO). Execution proceeds to S810 and the parser 33 completes the timer message processing shown in FIG. 10.

While the processing flow of successful communications with the printer has been described, communications with the printer 2 may fail in case the power switch of the printer 2 is turned OFF or in case a communication cable is removed from the printer 2. In such a case, the timer message processing will be described as follows.

In case it is determined that the communication failure counter value is below a prespecified value (for example 5), affirmative determination is made in S720 (S720: YES). In such a case, the parser 33 performs S730. Communications with the printer 2 are unsuccessful so that it is determined that communications are unsuccessful in S740 (S740: YES). In this case, the communication failure counter is incremented (S850) and execution proceeds to S810 described above, and the parser 33 completes the timer message processing shown in FIG. 10.

The timer message processing is repeated each time a predetermined time has elapsed as described earlier. The processing described above is repeated several times and S850 is repeated each time the processing is repeated, thus causing the value of the communication failure counter to exceed the prespecified value (for example 5).

In case the value of the communication failure counter is equal to or above a prespecified value (for example 5), negative determination is made in S720 (S720: NO). In this case, the parser 33 determines whether the communication unavailability indication flag is OFF (S860).

In case the communication unavailability indication flag is OFF in S860 (S860: YES), information indicating that communications with the printer 2 are unavailable (communication unavailability information) is not yet transmitted to the status monitor UI 32. In this case, the parser 33 writes the communication unavailability information into a report buffer (S870), turns ON the communication unavailability indication flag (S880) and execution proceeds to S840. The parser 33 thus transmits a status update message to the process of the status monitor UI 32. Execution then proceeds to S810 described above and the timer message processing shown in FIG. 10 is terminated.

In case the communication unavailability indication flag is not OFF in S860 (S860: NO), information indicating that communications with the printer 2 are unavailable (communication unavailability information) has been transmitted to the status monitor UI 32. In this case, execution proceeds to S810 described above without the status monitor UI 32 being notified of the communication unavailability information and the timer message processing shown in FIG. 10 is terminated.

A device configuration change message may be generated even when communications with the printer 2 are unavailable. This message temporarily turns ON the device connect/disconnect flag (S670). In the next timer message process, even when the value of the communication failure counter is equal to or above a prespecified value, data reception processing is made in S730. Meanwhile the device connect/disconnect flag is turned OFF in S810, so that data reception occurs only once and there is virtually no influence.

The above processing pertains to a case where successful communications with the printer 2 is unavailable. Communications with the printer 2 may be restored to normal such as in the case the power switch of the printer 2 is turned ON again or when a communication cable to the printer 2 is inserted into the connector again. In such a case, the above-mentioned device configuration change message processing (FIG. 9) is performed and the device connect/disconnect flag is turned ON. The timer message processing will be described as follows:

In S710, it is determined that the device connect/disconnect flag is ON (S710: YES). Execution skips S720 and proceeds to S730. In case the device connect/disconnect flag is ON, processing is made equivalent to that assumed when the value of the communication failure counter is below a prespecified value irrespective of whether the value of the communication failure counter is below a prespecified value. Thus, S730 and S740 are performed. In case communications are successful (S740: NO), the communication failure counter is zero-cleared even when the value of the communication failure counter is equal to or above a prespecified value.

In case the power switch of the printer 2 is turned ON again, the printer 2 is not brought into a state where it can provide state information unless a state information request command is transmitted to the printer 2. Even when it is determined that communications are successful in S740, it is determined that there is no acquired data in S760. At this point in time, the device connect/disconnect flag is ON so that affirmative determination is made in S770. As a result, execution proceeds to S790, where the parser 33 transmits a state information request command to the printer 2. Thereafter the printer 2 can provide state information.

In case the plug is inserted/removed while the printer 2 is powered ON, the printer 2 maintains a state where it can return state information although the display on the UI of the PC 1 may be “information indicating that communications with the printer are unavailable”. In such a case also, an INFO command of PJL is used to return information even when there is no status change in the printer. When the information is received, the status information is normally updated by the processing of S760 to S820 to S830.

In the above aspect, even in case a device other than the printer 2 is connected/disconnected, a PJL command is transmitted to the printer when a particular condition is satisfied. The printer 2 maintains the same state after receiving the USTATUS ON command more than once so that there is no influence. The INFO command is used to return the state at that point in time although there is no state change. The same status remains on the UI of the PC 1, which presents no problems.

As described hereinabove, according to the PC 1, a state information request command is not transmitted to the printer 2 when a message is received from the PnP manager 43, but the state information request command is transmitted to the printer 2 in case it is determined that communications with the printer 2 are available in S740. This prevents various problems caused by a situation where a state information request command is transmitted to the printer 2 while communications with the printer 2 are unavailable. In case communications with the printer 2 are available, a state information request command is transmitted to the printer 2 and it is possible to appropriately acquire state information from the printer 2 thereafter.

According to the PC 1, in case state information cannot be acquired, affirmative determination is made in S760 and execution proceeds to S790 followed by transmission of a state information request command to the printer 2. In case state information can be acquired, negative determination is made in S760 and execution proceeds to S820 and a state information request command is not transmitted to the printer 2. This prevents a state information request command from being transmitted uselessly although the printer 2 can be acquired state information.

According to the PC 1, in case it is determined that communication unavailability information should be transmitted to the user on the condition that the value of the communication failure counter is equal to or above a prespecified value in S720 and on the condition that the communication unavailability indication flag is OFF in S860, the communication unavailability information is transmitted to the status monitor UI 32 by the processing of S870 to S840 and the communication unavailability information is displayed on the display unit 16 to notify the user. The user thus recognizes that the computer cannot communicate with the printer 2 and may take proper action as required.

While an aspect of the invention has been described, the invention is not limited to the particular aspect but may be implemented in a variety of other forms.

For example, while the status monitor UI 32 displays state information on the display unit 16 of the PC 1, a specific destination is arbitrary. For example, state information may be output as a log to a file. A printer dedicated to outputting log may be provided to generate printouts. State information may be temporarily output to a file and the file may be displayed by using a general-purpose display program.

While the specifications of a particular printer board or specifications of a particular printer are illustrated in the aspect, the specifications of a printer board or specifications of a printer are not particularly limited. A target device may be a device other than a printer.

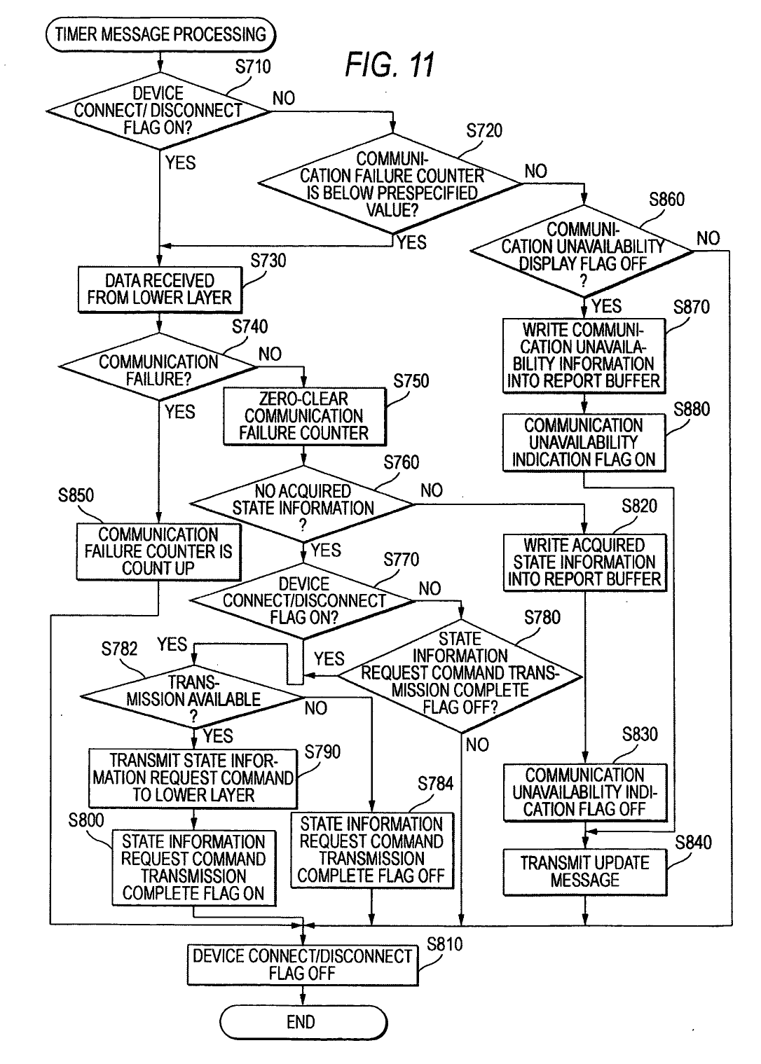

For example, in case a particular printer connected to an LPT port is powered ON with its cover open, the printer is in the offline sate and rejects a state information request command in S790 so that PJL commands of state information request commands are accumulated in a spooler. In this case, as shown in FIG. 11, processing (S782) is added to determine whether a state information request command can be transmitted to a printer before the processing S790 and in case a state information request command can be transmitted (S782: YES), the state information request command is transmitted in S790. Otherwise (S782: NO), the state information request command transmission complete flag is turned OFF (S784) and the state information request command is transmitted as soon as the state information request command can be transmitted to the printer at a later time.

While specific examples such as a message and a shared memory is used as means for performing inter-process communications between the status monitor UI 32 and the parser 33, the means for performing inter-process communication is arbitrary and any communication means such as Mutex and semaphore may be used. The status monitor UI 32 and the parser 33 may be separate processes or the same process. A single process may function having the features of the status monitor UI 32 and the parser 33. While the arbitrator 34 is provided as a dynamic link library so as to dynamically link an arbitrator 34 requiring the parser 33 in order to coordinate the parser 33 and the arbitrator 34, an arbitrator requiring the parser 33 maybe activated as a separate process. In this case, similar to a method for coordinating the status monitor UI 32 and the parser 33, the parser 33 and the arbitrator 34 may perform inter-process communications to transmit necessary information to each other. That is, the status monitor UI 32, parser 33 and arbitrator 34 may be based on processes by whatever feature or a single process as long as the respective features can be implemented.

According to the above aspects, it is possible to detect a change in connection with various devices based on the information from an information processing apparatus by using a feature included in the information processing apparatus.

According to the above aspects, although a state information request command is transmitted to a target device in a case when state information is not acquired, the state information request command is not transmitted when state information is acquired. This presents a state information request command from being transmitted uselessly while the device is ready to acquire state information.

According to the above aspects, communication unavailability information is transmitted to the user at a point in time communication unavailability information to indicate that communications with the target device are unavailable should be transmitted to the user. The user thus recognizes that the computer cannot communicate with the target device and may take proper action as required.

According to the above aspects, it is determined that communication unavailability information should not be transmitted to the user when the number of times communications with the target device is determined to be unavailable is below a prespecified value. For example, in case a temporary communication error has occurred by some cause (for example, communication failure has occurred due to accidental noise), successful communication on the next occasion leaves the user unaware of any communication unavailability information. This prevents excessive chances of transmitting communication unavailability information, thus reducing the inconvenience to the user.

According to the above aspects, communication unavailability information is not transmitted to the user until a condition satisfied is canceled. This prevents the same communication unavailability information from being transmitted when the information has already been transmitted, thus reducing the inconvenience to the user.

According to the above aspects, the user knows the state of the target device based on the reported state information. This allows action to be taken as required.

According to the above aspects, in case the number of times communications with the target device has failed is equal to or above a prespecified value, acquisition of state information is halted. This prevents useless attempts of communications while communications with the target device are unavailable, thus reducing the load on the computer. In case information to notify a change in the connection state is received and it is determined that communications is available with the target device after acquisition of state information is halted, acquisition of state information is restarted. It is possible to appropriately acquire state information from the target device thereafter.

What is claimed is:

1. A state information acquisition processing program embodied on a computer-readable medium, which when executed on a computer provided for an information processing apparatus, enables the computer to perform predetermined operations, the predetermined operations comprising:
detecting a change in a state of connections between the information processing apparatus and devices;
determining whether communications are available with a target device that is switched, on receiving a state information request command after power on, to a state where state information indicating a state of the target device can be provided;
transmitting a state information request command to the target device when a change in the state of connections with the devices is detected and the communication availability determining determines that communications with the target device are available; and
acquiring the state information from the target device.

2. The state information acquisition processing program according to claim 1, wherein
the charge in state detects a change in the state of connections with the devices by receiving from the information processing apparatus information used to notify a change in the state of connections with the devices.

3. The state information acquisition processing program according to claim 2, wherein:
the predetermined operations further includes determining whether the state information has been acquired from the target device by the state information acquiring; and
the state information request command transmitting transmits a state information request command to the target device when a change in the connection state is detected by the change in state detecting, when the communication availability determining determines that communications with the target device are available, and when the acquisition determining determines that the state information is not acquired.

4. The state information acquisition processing program according to claim 2, wherein:
the predetermined operations further includes:
determining whether communication unavailability information indicating that communications with the target device are unavailable should be reported to a user based on a determination result by the communication availability determining; and
reporting the communication unavailability information to the user when the report necessity determining determines that communication unavailability information should be reported to the user.

5. The state information acquisition processing program according to claim 4, wherein
the report necessity determining determines that the communication unavailability information should be reported to the user when a condition is satisfied that a number of times communications with the target device are determined unavailable by the communication availability determining has reached a predetermined number.

6. The state information acquisition processing program according to claim 4, wherein
the report necessity determining does not determine that the communication unavailability information should be reported to the user unless a condition once satisfied is canceled.

7. The state information acquisition processing program according to claim 2, wherein:
the predetermined operations further includes reporting the state information acquired by the state information acquiring.

8. The state information acquisition processing program according to claim 2, wherein:
the predetermined operations further includes:
stopping acquisition of the state information when a condition is satisfied that a number of times communications with the target device are determined unavailable by the communication availability determining has reached a predetermined number; and
restarting acquisition of the state information by the state information acquiring when a change in the connection state is detected by the detecting after acquisition of the state information is stopped by the state information acquisition stopping and in case communications with the target device are determined to be available by the communication availability determining.

9. A state information acquisition apparatus comprising:
a detection unit that detects a change in the state of connections between the information processing apparatus and devices;
a communication availability determination unit that determines whether communications with a target device are available, the target device being switched to a state where the state information indicating a state of the device can be provided when a state information request command is received after power on;
a state information request command unit that transmits the state information request command to the target device when a change in the state of connections with the devices is detected and the communications availability determination unit determines that communications with the target device are available; and
a state information acquisition unit that acquires the state information from the target device.

10. A state information acquisition system comprising:
a target device that is switched, on receiving a state information request command after power on, to a state where state information indicating a state of the target device can be provided; and
a state information acquisition apparatus to which the target device can be connected, wherein
the state information acquisition apparatus includes:
a detection unit that detects a change in a state of connections between a information processing apparatus and devices;
a communication availability determination unit that determines whether communications with the target device are available;
a state information request command unit that transmits the state information request command to the target device when a change in the state of connections with the devices is detected and the communications availability determination unit determines that communications with the target device are available; and
a state information acquisition unit that acquires the state information from the target device.

11. A state information acquisition processing program embodied on a computer-readable medium, which when executed on a computer provided for an information processing apparatus, enables the computer to perform predetermined operations, the predetermined operations comprising:
detecting a change in the state of connections with devices;
acquiring state information from a target device, the target device being switched to a state where the state information indicating a state of the device can be provided when a state information request command is received after power on;
reporting the state information acquired by the state information acquiring when a change in the state of connections with the devices is detected; and
transmitting the state information request command to the target device when a change in the state of connections with the devices is detected.

12. A state information acquisition apparatus comprising:
a detection unit that detects a change in the state of connections with devices;
a communication acquisition unit that acquiring state information from a target device, the target device being switched to a state where the state information indicating a state of the device can be provided when a state information request command is received after power on;
a state information report unit that reports the acquired state information when a change in the state of connection with the devices is detected by the detection unit; and
a state information request command unit that transmits the state information request command to the target device when a change in the state of connections with the devices is detected.

13. A state information acquisition system comprising:
a target device that is switched, on receiving a state information request command after power on, to a state where state information indicating a state of the target device can be provided; and
a state information acquisition apparatus to which the target device can be connected, wherein
the state information acquisition apparatus includes:
a detection unit that detects a change in a state of connections with devices;
a communication acquisition unit that acquiring state information from a target device, the target device being switched to a state where the state information indicating a state of the device can be provided when a state information request command is received after power on;
a state information report unit that reports the state information acquired by the state information acquisition apparatus when a change in the state of connections with the devices is detected; and
a state information request command unit that transmits the state information request command to the target device when a change in the state of connections with the devices is detected.
